(19) United States
(12) Patent Application Publication
(10) Pub. No.: US 2010/0085454 A1
(43) Pub. Date: Apr. 8, 2010

(54) IMAGING APPARATUS AND METHOD OF DRIVING SOLID-STATE IMAGING DEVICE

(75) Inventor: Takashi GOTO, Kanagawa (JP)

Correspondence Address: Studebaker & Brackett PC, One Fountain Square, 11911 Freedom Drive, Suite 750, Reston, VA, 20190, US

(73) Assignee: FUJIFILM CORPORATION, Tokyo (JP)

(21) Appl. No.: 12/575,166

(22) Filed: Oct. 7, 2009

(30) Foreign Application Priority Data
Oct. 8, 2008 (JP) P2008-261678

(51) Int. Cl. H04N 5/335

(52) U.S. Cl. 348/294; 348/E05.091

(57) ABSTRACT

An imaging apparatus includes a control unit of performing a series of drive operations of discharging electric charges in photoelectric conversion portions of all pixel units to a semiconductor substrate, simultaneously starting an exposure in all the pixel units, injecting the electric charges generated in the photoelectric conversion portions during the exposure period into floating gates FG during the exposure period, reading first signals corresponding to the electric charges accumulated in the FG after the end of the exposure period, discharging the electric charges in the FG to writing drains and reading drains, and reading second signals corresponding to noises accumulated in the FG, at different times by lines and a CDS generating an image capturing signal for generating image data by subtracting the second signals from the first signals.

### CROSS-REFERENCE TO RELATED APPLICATIONS

This application claims the benefit of Japanese Patent Application No. 2008-261678, filed on Oct. 8, 2008, the entire contents of which are hereby incorporated by reference, the same as if set forth at length.

### BACKGROUND OF THE INVENTION

1. Technical Field

The present invention relates to an imaging apparatus having plural pixel units each including a photoelectric conversion portion.

2. Description of Related Art

A solid-state imaging apparatus which captures an image by injecting and accumulating electric charges, which generated in a photoelectric conversion element such as a photo diode (PD), into a floating gate (FG) serving as a charge accumulating portion by a MOS transistor having the FG and by reading out a signal corresponding to the electric charges accumulated in the FG was suggested.

The apparatus in JP 2002-280537 A describes that some electric charges may remain in the FG after the electric charges in the FG are erased. Until injecting the electric charges generated during an exposure period into the FG after erasing the electric charges in the FG, noise may occur around the FG and may be mixed into the FG. The remaining electric charges or noise cannot be said to have a constant amount in all the floating gates FG.

Accordingly, to take out only the signal corresponding to the electric charges generated in the PD during the exposure period, it is necessary to perform a process of subtracting a noise signal corresponding to the electric charges originally existing in the FG from the signal corresponding to the electric charges generated during the exposure period and injected into the FG every pixel.

In the apparatus described in JP 2002-280537 A, it is possible to perform the above-mentioned process in every pixel by providing a frame memory and acquiring and storing a noise signal of each pixel. However, when the frame memory is provided, the entire size of a chip increases, which is not desirable.

JP 2002-280537 A discloses a method of resetting a threshold value of a reading transistor of each pixel to a predetermined level (injecting or collecting electric charges into or from the FG) to reduce an influence of the noise signal, but it is difficult to avoid the threshold values from being irregular at the time of resetting.

### SUMMARY

Illustrative aspect of the invention is to provide an imaging apparatus and a method of driving a solid-state imaging device, which can allow taking a high-quality image with little noise.

An imaging apparatus includes pixel groups, a driving unit that independently performs a charge erasing drive operation, a first signal reading drive operation and a second signal reading drive operation for the respective pixel groups and a signal generating unit. The each pixel group includes plural pixel units. The each pixel unit includes a photoelectric conversion portion, and a transistor having a charge accumulating portion which is disposed above a semiconductor substrate and which accumulates electric charges generated in the photoelectric conversion portion. The charge erasing drive operation discharges and erases the electric charges in the charge accumulating portions of the pixel units of each pixel group to drain regions of the transistors of the pixel units of each pixel group. The first signal reading device operation is performed after the electric charges which are generated during an exposure period are accumulated in the charge accumulating portion. The first signal reading device operation reads first signals corresponding to the electric charges accumulated in the charge accumulating portions of each pixel group. The second signal drive operation reads second signals corresponding to the electric charges in the charge accumulating portions of each pixel group after the electric charges in the charge accumulating portions of each pixel group are discharged to the drain regions of the transistors of each pixel group by the charge erasing drive operation. The signal generating unit generates a signal for generation of image data, by acquiring the first signal and the second signal which are read from the same pixel unit and subtracting the second signal from the first signal.

With this configuration, it is possible to remove the dark noise by reading the first signal and the second signal from each pixel unit and taking the difference therebetween. Since the second signal is acquired from each pixel unit, it is possible to provide a high-quality image with a reduced fixed pattern noise. Since the first signal and the second signal can be read at different times by the pixel groups, it is possible to generate the signal for generating the image data for every pixel group. Therefore, if a memory having the capacity enough to store the second signals read from one pixel group is provided, it is sufficient. Accordingly, it is possible to accomplish a decrease in the size of the imaging apparatus and in cost, compared with the case where a frame memory for storing the dark noises at the time of reading the second signals read from the entirety of the pixel units is provided.

In the imaging apparatus, the driving unit performs a substrate discharging drive operation of simultaneously discharging the electric charges generated in the photoelectric conversion portions of all the pixel units to the semiconductor substrate. In a still image capturing mode, the driving unit performs the substrate discharging drive operation and simultaneously starts the exposure period in all the pixel units, and then performs a series of the first signal reading drive operation, the charge erasing drive operation and the second signal reading drive operation in this order for each pixel group after an end of exposure period. Timings at which the series of the first signal reading drive operation, the charge erasing drive operation and the second signal reading drive operation are performed for the respective pixel groups are different from each other.

With this configuration, in the still image capturing mode, the global shutter operation of simultaneously starting the exposure in all the pixel units can be realized, thereby obtaining a high-quality still image without any distortion.

In the imaging apparatus, the transistor of each pixel unit is a writing transistor for injecting and accumulating the electric charges in the charge accumulating portion of each pixel unit. The driving unit drives the writing transistors to inject the electric charges, which are generated in the photoelectric conversion portions during the exposure period, into the charge accumulating portions during the exposure period.

With this configuration, since the electric charges are injected into the charge accumulating portion during the exposure period, it is possible to reduce the time taken to capture an image.

In the imaging apparatus, the transistor of each pixel unit is a writing transistor for injecting and accumulating the electric charges in the charge accumulating portion of each pixel unit. The driving unit drives the writing transistors to stop, during the exposure period, injecting the electric charges, which are generated in the photoelectric conversion portions, into the charge accumulating portions, and drives the writing transistors to inject the electric charges, which are generated in the photoelectric conversion portions during the exposure period, into the charge accumulating portions after an end of the exposure period.

With this configuration, since the charges are not injected into the charge accumulating portion during the exposure period, it is possible to prevent the noises generated during the exposure period from going into the charge accumulating portion, thereby reducing the noise.

In the imaging apparatus, the driving unit performs a discharging drive operation of discharging the electric charges generated in the photoelectric conversion portion of each pixel unit to the drain region of the transistor in each pixel unit. In a moving image capturing mode, the driving unit performs a series of (I) the discharging drive operation, (II) starting of the exposure period, (III) the first signal reading drive operation, (IV) the charge erasing drive operation, and (V) the second signal reading drive operation in this order for each pixel groups. Timings at which the series of (I) the discharging drive operation, (II) the starting of the exposure period, (III) the first signal reading drive operation, (IV) the charge erasing drive operation, and (V) the second signal reading drive operation are performed for the respective pixel groups are different from each other.

With this configuration, in the moving image capturing mode, it is possible to capture an image by the so-called rolling shutter operation in which the exposure period varies depending on the groups. In this way, the still image capturing by the global shutter operation and the moving image capturing by the rolling shutter operation can be carried out by only switching the driving methods. Therefore, it is possible to provide an imaging apparatus in which a natural and smooth moving image capturing is consistently achieved with the high-quality still image capturing at a low cost.

In the imaging apparatus, the transistor of each pixel unit is a writing transistor for injecting and accumulating the electric charges in the charge accumulating portion of each pixel unit. The driving unit drives the writing transistors to inject the electric charges, which are generated in the photoelectric conversion portions during the exposure period, into the charge accumulating portions during the exposure period.

With this configuration, since the charges are injected into the charge accumulating portion during the exposure period, it is possible to reduce the time taken to capture an image.

In the imaging apparatus, the transistor of each pixel unit is a writing transistor for injecting and accumulating the electric charges in the charge accumulating portion of each pixel unit. The driving unit drives the writing transistors to stop, during the exposure period, injecting the electric charges, which are generated in the photoelectric conversion portions, into the charge accumulating portions, and drives the writing transistors to inject the electric charges, which are generated in the photoelectric conversion portions during the exposure period, into the charge accumulating portions after the end of the exposure period.

With this configuration, since the charges are not injected into the charge accumulating portion during the exposure period, it is possible to prevent the noises generated during the exposure period from going into the charge accumulating portion, thereby reducing the noise.

In the imaging apparatus, the driving unit performs a discharging drive operation of discharging the electric charges generated in the photoelectric conversion portion of each pixel unit to the drain region of the transistor in each pixel unit. The transistor of each pixel unit is a writing transistor for injecting and accumulating the electric charges in the charge accumulating portion of each pixel unit. In a moving image capturing mode, the driving unit performs a series of (I) the discharging drive operation, (II) starting of the exposure period, (III) the charge erasing drive operation, (IV) the second signal reading drive operation, (V) an operation of driving the writing transistor after an end of the exposure period to inject the electric charges, which are generated in the photoelectric conversion portion during the exposure period, into the charge accumulating portion and (VI) the first signal reading drive operation in this order for each pixel group. Timings at which the series of (I) the discharging drive operation, (II) the starting of the exposure period, (III) the charge erasing drive operation, (IV) the second signal reading drive operation, (V) the operation of driving the writing transistor after the end of the exposure period and (VI) the first signal reading drive operation are performed for the respective pixel groups are different from each other.

With this configuration, since the charge erasing drive operation, the second signal reading drive operation, the charge injecting operation, and the first signal reading drive operation are carried out in this order after the start of the exposure, it is possible to read the first signal including the second signal as the dark noise after reading the second signal. Therefore, the signal obtained by subtracting the second signal from the first signal is accurately matched with the signal corresponding to the charges generated in the photoelectric conversion portion during the exposure period, thereby accurately removing the dark noise.

In the imaging apparatus, the discharging drive operation is a drive operation of discharging the electric charges generated in the photoelectric conversion portions of each pixel group to the drain regions of the writing transistors of each pixel group through channel regions of the writing transistors of each pixel group by applying to the gate electrodes of the writing transistors of each pixel group a second voltage lower than a first voltage to be applied to the gate electrodes of the writing transistors of each pixel group to inject the electric charges into the charge accumulating portions of each pixel group by the use of the writing transistors of each pixel group.

In the imaging apparatus, each pixel unit further includes a reading transistor for reading a signal corresponding to the electric charges accumulated in the charge accumulating portion. In each pixel unit, the charge accumulating portion includes a floating gate, and the floating gate of the writing transistor and a floating gate of the reading transistor are electrically connected to each other. The discharging drive operation is a drive operation of injecting the electric charges generated in the photoelectric conversion portions of each pixel group into the floating gates of the writing transistors of each pixel group and discharging the electric charges injected into the floating gates of each pixel group to the drain region of the reading transistors of each pixel group.

In the imaging apparatus, the writing transistors inject the electric charges using a hot electron injection method.

In the imaging apparatus, the writing transistors inject the electric charges using a tunnel electron injection method.

In the imaging apparatus, each photoelectric conversion portion includes a photoelectric conversion element disposed above the semiconductor substrate.

In the imaging apparatus, each photoelectric conversion element is formed of one of an amorphous silicon, a CIGS (Copper-Indium-gallium-selenium)-based material, and an organic material.

A method of driving a solid-state imaging device includes pixel groups. Each pixel group includes plural pixel units. Each pixel unit includes a photoelectric conversion portion, and a transistor having a charge accumulating portion which is disposed above a semiconductor substrate and which accumulates electric charges generated in the photoelectric conversion portion. The method includes independently performing a charge erasing drive operation, a first signal reading drive operation and a second signal reading drive operation for the respective pixel groups; and generating a signal for generation of image data. The charge erasing drive operation discharges and erases the electric charges in the charge accumulating portions of the pixel units of each pixel group to drain regions of the transistors of the pixel units of each pixel group. The first signal reading device operation is performed after the electric charges which are generated during an exposure period are accumulated in the charge accumulating portion. The first signal reading device operation reads first signals corresponding to the electric charges accumulated in the charge accumulating portions of each pixel group. The second signal drive operation reads second signals corresponding to the electric charges in the charge accumulating portions of each pixel group after the electric charges in the charge accumulating portions of each pixel group are discharged to the drain regions of the transistors of each pixel group by the charge erasing drive operation. The generating of the signal includes acquiring the first signal and the second signal which are read from the same pixel unit and subtracting the second signal from the first signal.

In the method of driving a solid-state imaging device, in a still image capturing mode, a substrate discharging drive operation of simultaneously discharging the electric charges generated in the photoelectric conversion portions of all the pixel units to the semiconductor substrate is performed. The exposure period in all the pixel units are started simultaneously. A series of the first signal reading drive operation, the charge erasing drive operation and the second signal reading drive operation are performed in this order for each pixel group after an end of exposure period. Timings at which the series of the first signal reading drive operation, the charge erasing drive operation and the second signal reading drive operation are performed for the respective pixel groups are different from each other.

In the method of driving a solid-state imaging device, the transistor of each pixel unit is a writing transistor for injecting and accumulating the electric charges in the charge accumulating portion of each pixel unit. The writing transistors are driven during the exposure period to inject the electric charges, which are generated in the photoelectric conversion portions during the exposure period, into the charge accumulating portions.

In the method of driving a solid-state imaging device, the transistor of each pixel unit is a writing transistor for injecting and accumulating the electric charges in the charge accumulating portion of each pixel unit. The writing transistors are driven to stop, during the exposure period, injecting the electric charges, which are generated in the photoelectric conversion portions, into the charge accumulating portions. After an end of the exposure period, the writing transistors are driven to inject the electric charges, which are generated in the photoelectric conversion portions during the exposure period, into the charge accumulating portions.

In the method of driving a solid-state imaging device, in a moving image capturing mode, a discharging drive operation of discharging the electric charges generated in the photoelectric conversion portion of each pixel unit to the drain region of the transistor in each pixel unit. A series of (I) the discharging drive operation, (II) starting of the exposure period, (III) the first signal reading drive operation, (IV) the charge erasing drive operation, and (V) the second signal reading drive operation are performed in this order for each pixel groups. Timings at which the series of (I) the discharging drive operation, (II) the starting of the exposure period, (III) the first signal reading drive operation, (IV) the charge erasing drive operation, and (V) the second signal reading drive operation are performed for the respective pixel groups are different from each other.

In the method of driving a solid-state imaging device, the transistor of each pixel unit is a writing transistor for injecting and accumulating the electric charges in the charge accumulating portion of each pixel unit. The writing transistors are driven during the exposure period to inject the electric charges, which are generated in the photoelectric conversion portions during the exposure period, into the charge accumulating portions.

In the method of driving a solid-state imaging device, the transistor of each pixel unit is a writing transistor for injecting and accumulating the electric charges in the charge accumulating portion of each pixel unit. The writing transistors are driven to stop, during the exposure period, injecting the electric charges, which are generated in the photoelectric conversion portions, into the charge accumulating portions. After an end of the exposure period, the writing transistors are driven to inject the electric charges, which are generated in the photoelectric conversion portions during the exposure period, into the charge accumulating portions.

In the method of driving a solid-state imaging device, the transistor of each pixel unit is a writing transistor for injecting and accumulating the electric charges in the charge accumulating portion of each pixel unit. In a moving image capturing mode, a discharging drive operation of discharging the electric charges generated in the photoelectric conversion portion of each pixel unit to the drain region of the transistor in the pixel unit is performed. A series of (I) the discharging drive operation, (II) starting of the exposure period, (III) the charge erasing drive operation, (IV) the second signal reading drive operation, (V) an operation of driving the writing transistor after an end of the exposure period to inject the electric charges, which are generated in the photoelectric conversion portion during the exposure period, into the charge accumulating portion and (VI) the first signal reading drive operation are performed in this order for each pixel group. Timings at which the series of (I) the discharging drive operation, (II) the starting of the exposure period, (III) the charge erasing drive operation, (IV) the second signal reading drive operation, (V) the operation of driving the writing transistor after the end of the exposure period into the charge accumulating portion and (VI) the first signal reading drive operation for the respective pixel groups are different from each other.

In the method of driving a solid-state imaging device, the discharging drive operation is a drive operation of discharging the electric charges generated in the photoelectric conversion portions of each pixel group to the drain regions of the writing transistors of each pixel group through channel regions of the writing transistors of each pixel group by applying to the gate electrodes of the writing transistors of each pixel group a second voltage lower than a first voltage to be applied to the gate electrodes of the writing transistors of each pixel group to inject the electric charges into the charge accumulating portions of each pixel group by the use of the writing transistors of each pixel group.

In the method of driving a solid-state imaging device, each pixel unit further includes a reading transistor for reading a signal corresponding to the electric charges accumulated in the charge accumulating portion. In each pixel unit, the charge accumulating portion includes a floating gate, and the floating gate of the writing transistor and a floating gate of the reading transistor are electrically connected to each other. The discharging drive operation is a drive operation of injecting the electric charges generated in the photoelectric conversion portions of each pixel group into the floating gates of the writing transistors of each pixel group and discharging the electric charges injected into the floating gates of each pixel group to the drain region of the reading transistors of each pixel group.

In the method of driving a solid-state imaging device, the writing transistors are driven so as to inject the electric charges using a hot electron injection method.

In the method of driving a solid-state imaging device, the writing transistors are driven so as to inject the electric charges using a tunnel electron injection method.

In the method of driving a solid-state imaging device, each photoelectric conversion portion includes a photoelectric conversion element disposed above the semiconductor substrate.

In the method of driving a solid-state imaging device, each photoelectric conversion element is formed of one of an amorphous silicon, a CIGS (Copper-Indium-gallium-selenium)-based material, and an organic material.

According to the invention, it is possible to provide an imaging apparatus and a method of driving a solid-state imaging device, which can allow taking a high-quality image with little noise.

### BRIEF DESCRIPTION OF THE DRAWINGS

FIG. 1A is a plan view schematically illustrating the configuration of a solid-state imaging device according to an embodiment of the invention.

FIG. 1B is a view schematically illustrating the configuration of a reading circuit 20 shown in FIG. 1A.

FIG. 2 is a sectional view schematically illustrating the configuration of a pixel unit shown in FIG. 1A.

FIG. 3 is an equivalent circuit diagram of the pixel unit shown in FIG. 1A.

FIG. 4 is a timing diagram illustrating a driving method in a still image capturing mode in the solid-state imaging device shown in FIG. 1A.

FIG. 5 is a timing diagram illustrating a driving method in a moving image capturing mode in the solid-state imaging device shown in FIG. 1A.

FIG. 6 is a timing diagram illustrating a modified example of the driving method in a still image capturing mode shown in FIG. 4.

FIG. 7 is a timing diagram illustrating a modified example of the driving method in a moving image capturing mode shown in FIG. 5.

FIG. 8 is a sectional view schematically illustrating another configuration of a pixel unit of the solid-state imaging device shown in FIG. 1A.

### DETAILED DESCRIPTION OF EMBODIMENTS OF THE INVENTION

Hereinafter, a solid-state imaging device according to an embodiment of the invention will be described with reference to the accompanying drawings. The solid-state imaging device is mounted on an imaging apparatus such as a digital camera or a digital video camera.

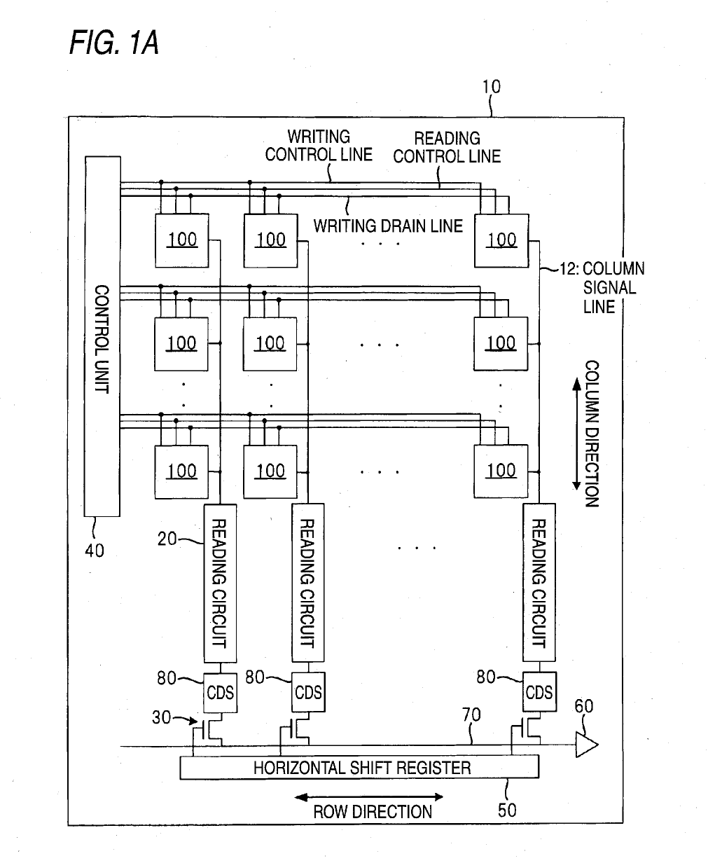

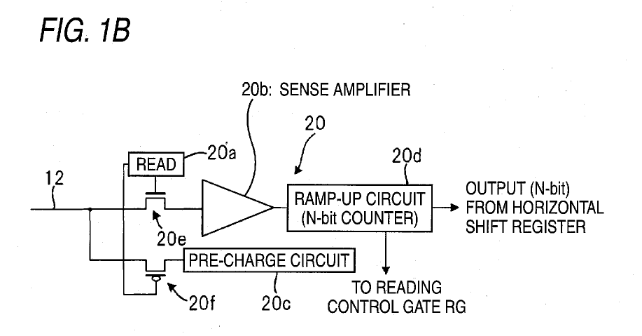

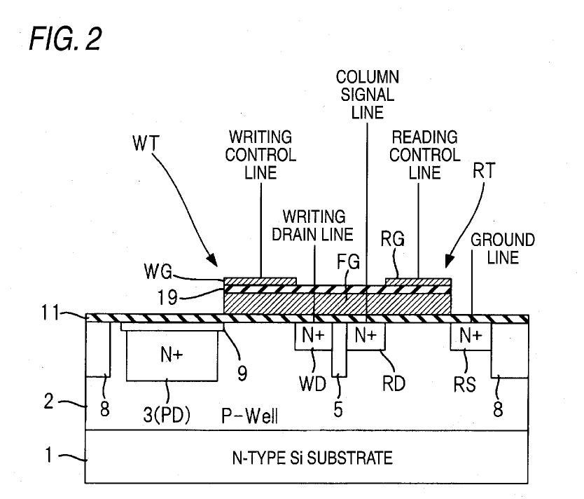

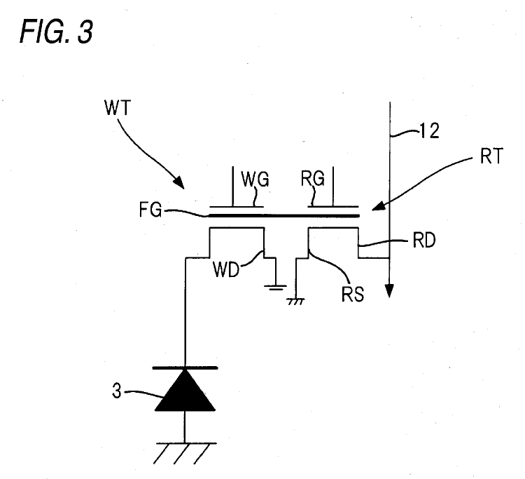

FIG. 1A is a plan view schematically illustrating the configuration of a solid-state imaging device according to an embodiment of the invention. FIG. 2 is a sectional view schematically illustrating the configuration of a pixel unit shown in FIG. 1A. FIG. 3 is an equivalent circuit diagram of the pixel unit shown in FIG. 2.

The solid-state imaging device 10 includes plural pixel units 100 arranged in an array (herein, in a square lattice shape) in a row direction and a column direction perpendicular thereto in the same plane.

Each pixel unit 100 has an N-type impurity layer 3 formed in a semiconductor substrate including an N-type silicon substrate 1 and a P-well layer 2 formed thereon. The N-type impurity layer 3 is formed in the P-well layer 2 and a photo diode (PD) serving as a photoelectric conversion portion is formed by the PN junction of the N-type impurity layer 3 and the P-well layer 2. Hereinafter, the N-type impurity layer 3 is called photoelectric conversion portion 3. The photoelectric conversion portion 3 is a so-called embedded photo diode in which a P-type impurity layer 9 for complete depletion or suppression of dark current is formed on the surface thereof.

A reading portion capable of reading out a voltage signal corresponding to the charges generated in the photoelectric conversion portion 3 is formed in the semiconductor substrate.

The reading portion includes a writing transistor WT and a reading transistor RT. The writing transistor WT and the reading transistor RT are separated from each other by an element separating region 5 disposed slightly apart to the right from the photoelectric conversion portion 3. The elements of the pixel units 100 in the P-well layer 2 are separated from each other by the element separating region 8.

As an element separating method, a LOCOS (Local Oxidation of Silicon) method, an STI (Shallow Trench Isolation) method, a high-concentration impurity ion implanting method, and the like can be employed.

The writing transistor WT has an MOS transistor structure having a photoelectric conversion portion 3 serving as a source region, a writing drain WD which is a drain region formed of a high-concentration N-type impurity region disposed slightly apart to the right from the photoelectric conversion portion 3, a writing control gate WG which is a gate electrode disposed above the semiconductor substrate between the photoelectric conversion portion 3 and the writing drain WD with an oxide film 11 interposed therebetween, and a floating gate FG disposed between the writing control gate WG and the oxide film 11.

For example, polysilicon can be used as a conductive material of the writing control gate WG. Doped polysilicon doped with phosphorus (P), arsenic (As), and boron (B) at a high concentration may be used. Alternatively, silicide or salicide (self-aligned silicide) in which various metals such as titanium (Ti) or tungsten (W) are combined with silicon may be used.

The reading transistor RT has an MOS transistor structure including a reading drain RD which is a drain region formed of a high-concentration N-type impurity region disposed on the right side of the element separating region 5, a reading source RS which is a source region formed of an N-type impurity region disposed slightly apart to the right from the reading drain RD, a reading control gate RG which is a gate electrode disposed above the semiconductor substrate between the reading drain RD and the reading source RS with an oxide film 11 interposed therebetween, and a floating gate FG disposed between the reading control gate RG and the oxide film 11.

The same material as the writing control gate WG can be used as the conductive material of the reading control gate RG. A column signal line 12 is connected to the reading drain RD and a ground line is connected to the reading source RS. The impurity concentration of the reading drain RD is adjusted to form an ohmic contact with the column signal line 12. The impurity concentration of the reading source RS is adjusted to form an ohmic contact with the ground line.

The floating gate FG is an electrically floating electrode disposed above the semiconductor substrate between the P-type impurity layer 9 and the reading source RS with the oxide film 11 interposed therebetween. The writing control gate WG and the reading control gate RG are disposed above the floating gate FG with an insulating film 19 of silicon oxide or the like interposed therebetween. The same material as the writing control gate WG can be used as the conductive material of the floating gate FG.

The floating gate FG is not limited to a sheet lump common to the writing transistor WT and the reading transistor RT, but may have a structure in which the floating gates FG are individually provided to the writing transistor WT and the reading transistor RT and the separated two floating gates FG are electrically connected by a wire. The writing control gate WG and the photoelectric conversion portion 3 may partially overlap with each other so as to easily inject charges from the photoelectric conversion portion 3 to the floating gate FG.

The pixel unit 100 has a structure in which light is incident on only a part of the photoelectric conversion portion 3 by a light-blocking film not shown.

The solid-state imaging device 10 includes a control unit 40 controlling the writing transistor WT and the reading transistor RT, a reading circuit 20 detecting the threshold voltage of the reading transistor RT, a CDS 80 connected to the reading circuit 20, a horizontal shift register 50 sequentially reading image capturing signals of one line output from the CDS 80 to the signal line 70, and an output amplifier 60 connected to the signal line 70.

The reading circuit 20 is provided to correspond to each column including plural pixel units 100 arranged in the column direction and is connected to the reading drains RD of the pixel units 100 in the corresponding column via the column signal line 12. The reading circuit 20 is also connected to the control unit 40.

As shown in FIG. 1B, the reading circuit 20 includes a reading controller 20a, a sense amplifier 20b, a pre-charge circuit 20c, a ramp-up circuit 20d, and transistors 20e and 20f.

At the time of reading a signal from the pixel units 100, the reading controller 20a supplies a drain voltage (Vr) from the pre-charge circuit 20c to the reading drains RD of the pixel unit 100 via the column signal line 12 by turning on the transistor 20f (pre-charge). Then, the reading controller 20a electrically connects the reading drains RD of the pixel units 100 to the sense amplifier 20b by turning on the transistor 20e.

The sense amplifier 20b monitors the voltage of the reading drains RD of the pixel units 100, detects the variation of the voltage, and notifies the ramp-up circuit 20d of the detection result. For example, the sense amplifier detects that the drain voltage pre-charged by the pre-charge circuit 20c is dropped and inverts the output of the sense amplifier.

The ramp-up circuit 20d has an N-bit counter built therein, supplies an increasing or decreasing ramp waveform voltage to the reading control gates RG of the pixel units 100 via the control unit 40, and outputs count values (N combinations of 1 and 0) corresponding to the value of the ramp waveform voltage.

When the voltage of the reading control gate RG is greater than the threshold voltage of the reading transistor RT, the reading transistor RT is turned on and the potential of the pre-charged column signal line 12 is dropped at this time. This voltage drop is detected by the sense amplifier 20b and an inverted signal is output. The ramp-up circuit 20d holds (latches) the count value corresponding to the value of the ramp waveform voltage at the time of receiving the inverted signal. Accordingly, the variation of the threshold voltage can be read as a digital value (a combination of 1 and 0).

The CDS 80 removes noises included in a voltage signal corresponding to the charges generated in the photoelectric conversion portion 3 of the corresponding pixel unit 100 and generates an image capturing signal for generating image data.

When one horizontal selection transistor 30 is selected by the horizontal shift register 50, the image capturing signal generated by the CDS 80 connected to the selected horizontal selection transistor 30 is output to the signal line 70 and is output from the output amplifier 60.

The method of allowing the reading circuit 20 to read the variation in threshold voltage of the reading transistor RT is not limited to the above-mentioned method. For example, the drain current of the reading transistor RT may be read as the image capturing signal when a constant voltage is applied to the reading control gate RG and the reading drain RD.

The control unit 40 is connected to the writing control gates WG, the reading control gates RG, and the writing drains WD of the pixel units 100 in the lines including plural pixel units 100 arranged in the row direction via the writing control line, the reading control line, and the writing drain line. The impurity concentration of the writing drain WD is adjusted to form an ohmic contact with the writing drain line.

The control unit 40 controls the writing transistor WT to inject and accumulate the charges generated in the photoelectric conversion portion 3 in the floating gate FG. The method of injecting the charges into the floating gate FG may employ a hot electron injection method of injecting the charges into the floating gate FG using hot electrons such as channel hot electrons (CHE) or a tunnel electron injection method of injecting the charges into the floating gate FG by tunneling using the Fowler-Nordheim (F-N) tunnel current.

The control unit 40 controls the reading transistor RT by the above-mentioned method to read the voltage signal corresponding to the charges accumulated in the floating gate FG.

The control unit 40 performs a discharging drive operation of discharging the charges generated and accumulated in the photoelectric conversion portion 3 just before the start of an exposure period (a period when the photoelectric conversion portion 3 is exposed to acquire the image capturing signal for generating one piece of image data) of each pixel unit 100 to empty the photoelectric conversion portion 3 and a charge erasing drive operation of discharging and erasing the charges accumulated in the floating gate FG.

The discharging drive operation includes two types of a drain discharging drive operation of discharging the charges generated in the photoelectric conversion portion 3 just before the start of the exposure period to the writing drain WD or the reading drain RD just before the start of the exposure period and a substrate discharging drive operation of discharging the charges generated in the photoelectric conversion portion 3 just before the start of the exposure period to the semiconductor substrate.

A specific example of the drain discharging drive operation includes a method of discharging the charges generated in the photoelectric conversion portion 3 to the writing drain WD through the channel region of the writing transistor WT by applying a second voltage (Vcc), which is lower than a first voltage (Vpp) to be applied to the writing control gate WG to inject the charges into the floating gate FG by the writing transistor WT and which is a voltage such as not to cause the injection of the charges into the floating gate FG, to the writing control gate WG and a method of injecting the charges generated in the photoelectric conversion portion 3 to the floating gate FG by the writing transistor WT and discharging the charges injected into the floating gate FG to the reading drain RD.

The charge erasing drive operation includes two types of a drain erasing drive operation of erasing the charges from the floating gate FG by applying a voltage (Vcc) having a first polarity (for example, positive polarity) to the writing drain WD and the reading drain RD and applying a voltage (−Vpp) having the opposite polarity (for example, negative polarity) of the first polarity to the writing control gate WG and the reading control gate RG so as to discharge the charges accumulated in the floating gate FG to the writing drain WD and the reading drain RD and a substrate erasing drive operation of erasing the charges by applying a positive voltage (Vcc) to the semiconductor substrate and applying a negative voltage (−Vpp) to the writing control gate WG and the reading control gate RG so as to pull out the charges accumulated in the floating gate FG to the semiconductor substrate.

The application of the voltage to the reading drain RD is carried out by controlling the reading controller 20a and the pre-charge circuit 20c. The pre-charge circuit 20c can generate two levels of voltages of a voltage (Vr) applied to the reading drain RD to read a voltage signal and a voltage (Vcc) applied to the reading drain RD to erase the charges and supply the generated voltages to the column signal line 12, and supplies the voltage Vcc to the reading drain RD under the control of the control unit 40 at the time of performing the drain erasing drive operation. The reading controller 20a turns off the transistor 20e and turns on the transistor 20f under the control of the control unit 40 at the time of performing the drain erasing drive operation.

In FIG. 1A, the control unit 40 is built in the solid-state imaging device 10, but the function of the control unit 40 may be given to the imaging apparatus mounted with the solid-state imaging device 10.

The method of driving the solid-state imaging device having the above-mentioned configuration will be described now. Hereinafter, an example where the charges are injected by a CHE injection method will be described.

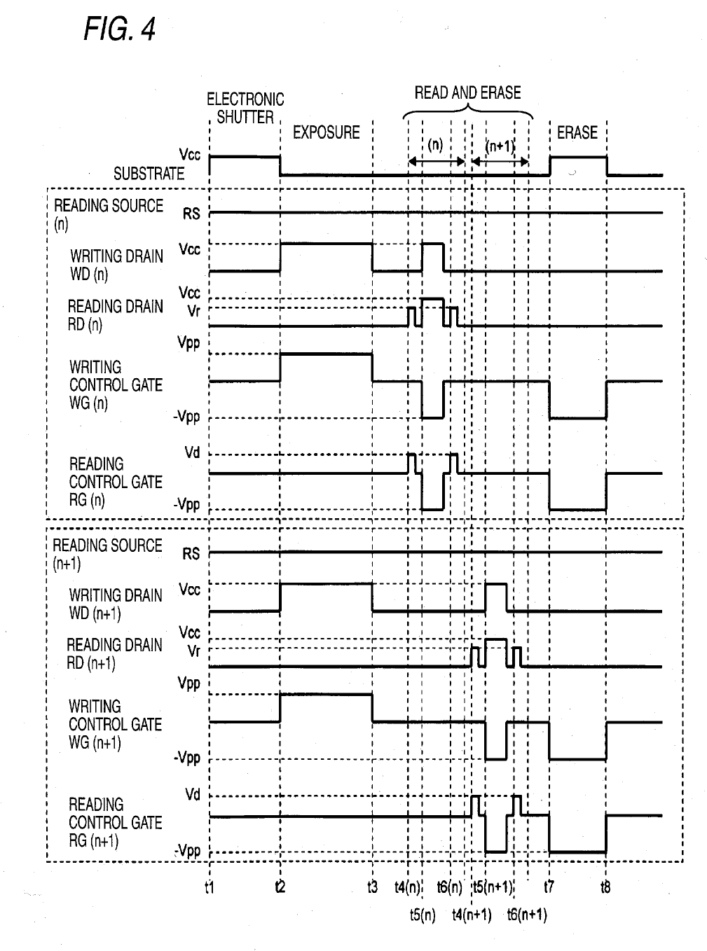

FIG. 4 is a timing diagram illustrating a driving method in the still image capturing mode in the solid-state imaging device shown in FIG. 1A. In FIG. 4, variations in potential of the portions of the pixel units 100 in the n-th line and variations in potential of the portions of the pixel units 100 in the (n+1)-th line are shown with the time. In FIG. 4, “(n)” or “(n+1)” added to the names of the elements of the solid-state imaging device indicates that the elements belong to the pixel units 100 in the n-th line or the (n+1)-th line. In the still image capturing mode, simultaneously all the pixel units 100 of the solid-state imaging device 10 are exposed and an image is captured.

First, at time t1 before the start of the exposure period, the control unit 40 sets the potential of the semiconductor substrate to Vcc as an electronic shutter operation and discharges the charges accumulated in the photoelectric conversion portions 3 of all the pixel units 100 before time t1 to the semiconductor substrate (substrate discharging drive). By this substrate discharging drive operation, the charges do not exist in the photoelectric conversion portions 3 of all the pixel units 100. Since the charges are erased from the floating gate FG before time t1, the charges are not accumulated in the floating gate FG at time t1. Therefore, the charges are not accumulated in the photoelectric conversion portions 3 and the floating gates FG of all the pixel units 100 by the discharging operation at time t1.

At time t2 which is the start time of the exposure period, the control unit 40 sets the potential of the semiconductor substrate to a low level. The control unit sets the potential of the writing control gates WG of all the pixel units 100 to Vpp and sets the potential of the writing drains WD to Vcc. By this voltage setting, the charges generated in the photoelectric conversion portions 3 during the exposure period are injected into the floating gates FG through the oxide film 11 (CHE injection).

To suppress the charges from leaking from the reading drains RD, it is preferable that the voltage of the reading drains RD of all the pixel units 100 may be set to the low level during the exposure period. Accordingly, it is possible to prevent the decrease in sensitivity.

When the injection of charges is carried out using the tunnel electron injection method, the potential of the writing drains WD during the exposure period can be set to the low level. When the drive operation of injecting the charges into the floating gates FG using the tunnel electron injection method is employed, it is possible to suppress the generation of dark current from the writing drains WD during the charge injection period into the floating gates FG, thereby providing a high-quality image with low noise.

In this way, the charges are simultaneously accumulated in all the pixel units 100 during the exposure period from time t2 to time t3. The thickness or the like of the oxide film 11 is adjusted to inject rapidly and satisfactorily the charges generated in the photoelectric conversion portions 3 into the floating gates FG.

At time t3 which is the end time of the exposure period, the control unit 40 sets the potentials of the writing control gates WG and the writing drains WD of all the pixel units 100 to the low level. Accordingly, the charges generated in the photoelectric conversion portions 3 of all the pixel units 100 after time t3 are not injected into the floating gates FG and the accumulation of charges is thus ended.

At time t4(n) which is the start time of the reading period for reading the image capturing signal from the pixel units 100 in the n-th line, the control unit 40 pre-charges the reading drains RD of the pixel units 100 in the n-th line and then starts applying a ramp waveform voltage to the reading control gates RG of the pixel units 100 in the n-th line (the waveform applied to the reading control gate RG is simplified in the drawing). The count value (first signal) corresponding to the value of the ramp waveform voltage at the time when the potential of the reading drains RD in the n-th line is dropped is held in the reading circuits 20 and the first signal is sampled and held by the CDS circuit 80.

When the output of the first signal from the pixel units 100 in the n-th line is ended, the control unit 40 performs the charge erasing drive operation (drain erasing drive operation) by setting the potentials of the writing control gates WG and the reading control gates RG of the pixel units 100 in the n-th line to −Vpp and setting the potentials of the writing drains WD and the reading drains RD of the pixel units 100 in the n-th line to Vcc (time t5(n)). Accordingly, the charges accumulated in the floating gates FG in the n-th line are discharged to the writing drains WD and the reading drains RD.

The control unit 40 ends the drain erasing drive operation by returning the potentials of the writing control gates WG, the reading control gates RG, the writing drains WD, and the reading drains RD of the pixel units 100 in the n-th line to the low level. Thereafter, at time t6(n), the control unit 40 pre-charges the reading drains RD of the pixel units 100 in the n-th line and then starts applying a ramp waveform voltage to the reading control gates RG of the pixel units 100 in the n-th line (the waveform applied to the reading control gate RG is simplified in the drawing). The count value (second signal) corresponding to the value of the ramp waveform voltage at the time the potential of the reading drains RD in the n-th line is dropped is held in the reading circuits 20 and the second signal is sampled and held by the CDS circuit 80.

The CDS circuits 80 hold the second signals read from the pixel units 100 in the n-th line and generates the image capturing signal for generating the image data by subtracting the second signals from the first signals held in advance and read from the pixel units 100 in the n-th line. Then, when one horizontal selection transistor 30 is selected by the horizontal shift register 50, the image capturing signal generated by the CDS 80 connected to the selected horizontal selection transistor 30 is output to the signal line 70 and is output from the output amplifier 60.

When the image capturing signal is output from the pixel units 100 in the n-th line, the control unit 40 pre-charges the reading drains RD of the pixel units 100 in the (n+1)-th line and then starts applying a ramp waveform voltage to the reading control gates RG of the pixel units 100 in the (n+1)-th line (time t4(n+1)). The count value (first signal) corresponding to the value of the ramp waveform voltage at the time when the potential of the reading drains RD in the (n+1)-th line is dropped is held in the reading circuits 20 and the first signal is sampled and held by the CDS circuit 80.

When the output of the first signal from the pixel units 100 in the (n+1)-th line is ended, the control unit 40 performs the charge erasing drive operation (drain erasing drive operation) by setting the potentials of the writing control gates WG and the reading control gates RG of the pixel units 100 in the (n+1)-th line to −Vpp and setting the potentials of the writing drains WD and the reading drains RD of the pixel units 100 in the (n+1)-th line to Vcc (time t5(n+1)). Accordingly, the charges accumulated in the floating gates FG in the (n+1)-th line are discharged to the writing drains WD and the reading drains RD.

The control unit 40 ends the drain erasing drive operation by returning the potentials of the writing control gates WG, the reading control gates RG, the writing drains WD, and the reading drains RD of the pixel units 100 in the (n+1)-th line to the low level. Thereafter, at time t6(n+1), the control unit 40 pre-charges the reading drains RD of the pixel units 100 in the (n+1)-th line and then starts applying a ramp waveform voltage to the reading control gates RG of the pixel units 100 in the (n+1)-th line. The count value (second signal) corresponding to the value of the ramp waveform voltage at the time when the potential of the reading drains RD in the (n+1)-th line is dropped is held in the reading circuits 20 and the second signal is sampled and held by the CDS circuit 80.

The CDS circuits 80 hold the second signals read from the pixel units 100 in the (n+1)-th line and generates the image capturing signal for generating the image data by subtracting the second signals from the first signals held in advance and read from the pixel units 100 in the (n+1)-th line. Then, when one horizontal selection transistor 30 is selected by the horizontal shift register 50, the image capturing signal generated by the CDS 80 connected to the selected horizontal selection transistor 30 is output to the signal line 70 and is output from the output amplifier 60.

In this way, the control unit 40 performs the drive operation of reading the image capturing signal at times different by (t4(n+1)−t4(n)) by the lines. Since the signal reading is carried out at every line, the reading wait period from time t3 to the start of the signal reading varies depending on the lines and is much greater than 1 msec in the longest line. Accordingly, the structure of the oxide film 11 is adjusted so as to prevent the charges from leaking in the exposure period and the reading wait period.

After sequentially reading the image capturing signals from all the pixel units 100, the control unit 40 performs the substrate erasing drive operation by setting the potentials of the writing control gates WG and the reading control gates RG of all the pixel units 100 to −Vpp and setting the potential of the semiconductor substrate to Vcc (time t7). Accordingly, the charges accumulated in the floating gates FG of all the pixel units 100 are discharged to the semiconductor substrate. By performing the substrate erasing drive operation, the time until the injection of the charges is started after the charges in the floating gates FG are erased can be kept constant in all the pixel units 100. Accordingly, it is possible to reduce the unevenness in noise accumulated in the floating gates FG, thereby improving the precision in reading the image capturing signal.

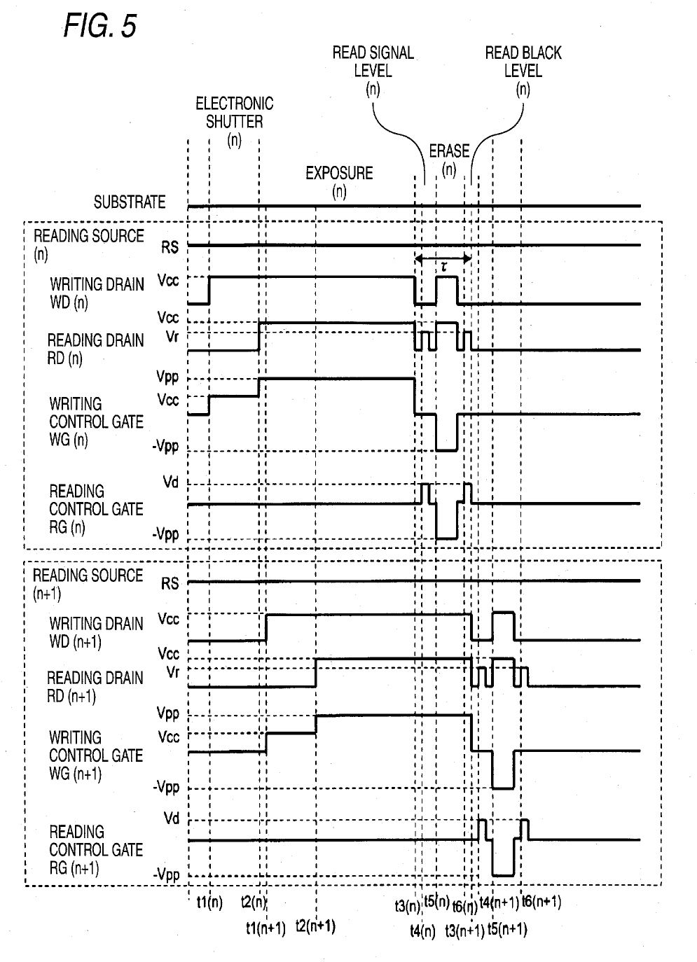

FIG. 5 is a timing diagram illustrating a driving method in the moving image capturing mode in the solid-state imaging device shown in FIG. 1A. In FIG. 5, variations in potential of the portions of the pixel units 100 in the n-th line and variations in potential of the portions of the pixel units 100 in the (n+1)-th line are shown with the time. In FIG. 5, “(n)” or “(n+1)” added to the names of the elements of the solid-state imaging device indicates that the elements belong to the pixel units 100 in the n-th line or the (n+1)-th line. In the moving image capturing mode, an image is captured at different times by the lines of the solid-state imaging device 10.

At time t1(n) just before time t2(n) which is the start time of the exposure period of the pixel units 100 in the n-th line, the control unit 40 performed the drain discharging operation by setting the potential of the writing drains WD and the writing control gates WG of the pixel units 100 in the n-th line to Vcc. Accordingly, the charges generated and accumulated in the photoelectric conversion portions 3 of the pixel units 100 in the n-th line before time t1(n) are not injected into the floating gates FG but moves to the writing drains WD through the channel regions of the writing transistors WT. Accordingly, the charges are not accumulated in the photoelectric conversion portions 3 of the pixel units 100 in the n-th line. Since the charges are erased from the floating gates FG before time t1(n), the charges are not also accumulated in the floating gates FG at time t1(n). Therefore, by the drain discharging operation at time t1(n), the charges are not accumulated in the photoelectric conversion portions 3 and the floating gates FG of the pixel units 100 in the n-th line.

At time t2(n), the control unit 40 sets the potential of the reading drains RD of the pixel units 100 in the n-th line to Vcc and sets the potential of the writing control gates WG to Vpp. By this voltage setting, the charges generated in the photoelectric conversion portions 3 during the exposure period are injected into the floating gates FG through the oxide film 11 (CHE injection).

To suppress the charges from leaking from the reading drains RD, it is preferable that the voltage of the reading drains RD of the pixel units 100 in the n-th line is set to the low level during the exposure period. Accordingly, it is possible to prevent the decrease in sensitivity. When the charges are injected using the tunnel electron injection method, the potential of the writing drains WD can be set to the low level during the exposure period.

At time t3(n) which is end time of the exposure period of the pixel units 100 in the n-th line, the control unit 40 sets the potentials of the writing control gates WG, the writing drains WD, and the reading drains RD of the pixel units 100 in the n-th line to the low level. Accordingly, the charges generated in the photoelectric conversion portions 3 of the pixel units 100 in the n-th line after time t3(n) are not injected into the floating gates FG and the accumulation of the charges is ended. The operation at times t4(n) to t6(n) is the same times t4(n) to t6(n)as shown in FIG. 4. In the moving image capturing mode, the substrate discharging drive operation (at times t7(n) to t8(n) in FIG. 4) is not driven.

After the end of the exposure period, the control unit 40 continuously performs the first signal reading operation, the charge erasing operation, and the second signal reading operation. When the time taken to perform the first signal reading operation, the charge erasing operation, and the second signal reading operation is τ, the control unit 40 performs the drive operations of times t1(n) to t6(n) at different times by the time τ by the lines. The times obtained by adding τ to times t1(n) to t6(n) are t1(n+1) to t6(n+1).

As described above, the solid-state imaging device 10 can generate the image capturing signal with a reduced noise by reading the first signal (the sum of the voltage signal corresponding to the charges generated in the photoelectric conversion portion 3 during the exposure period and the noise signal corresponding to the noise originally existing in the floating gate FG) and the second signal (the noise signal corresponding to the noise originally existing in the floating gate FG) from each pixel unit 100 and taking the difference therebetween.

Since the second signal is acquired from each pixel unit 100 and the process of subtracting the second signal from the first signal is carried out for each pixel unit 100, it is possible to provide a high-quality image in which a fixed pattern noise due to the unevenness in noise accumulated in the floating gates FG is suppressed. Since the charge erasing drive operation (drain erasing drive operation) is carried out for each line, it is possible to read the first signal and the second signal at different times by the lines. Therefore, if a memory having the capacity enough to store the second signals of one line is provided, it is sufficient. Accordingly, it is possible to accomplish the decrease in size of the imaging apparatus and the decrease in cost, compared with the case where a frame memory for storing the second signals read from all the pixel units 100 is provided.

In the solid-state imaging device 10, the so-called rolling shutter driving operation is realized in the moving image capturing mode by discharging the charges generated in the photoelectric conversion portions 3 at different times by the lines using the drain discharging drive method and reading the signals corresponding to the charges in the floating gates FG and erasing the charges therefrom at different times by the lines. In the still image capturing mode, the so-called global shutter driving operation is realized by simultaneously discharging the charges generated in the photoelectric conversion portions 3 of all the pixel units 100 using the substrate discharging drive method.

For the moving image capturing of continuously acquiring still image data such as video images at a high speed, a high-speed operation is required. The video images are generally displayed in a line sequential manner. Accordingly, as described above, it is possible to capture or display a natural and smooth moving image by employing the rolling shutter driving method in the moving image capturing mode. On the other hand, when the rolling shutter drive method is employed in the still image capturing mode, the distortion of an image can occur. Accordingly, it is preferable that an increase in image quality without any distortion is accomplished by employing the global shutter driving method.

According to the solid-state imaging device 10, since the global shutter driving operation and the rolling shutter driving operation can be switched by only changing the drive method, it is possible to suppress the increase in manufacturing cost.

In the driving methods shown in FIGS. 4 and 5, the exposure and the injection of the charges generated in the photoelectric conversion portions 3 at the time of exposure into the floating gates FG are simultaneously carried out. However, the exposure and the injection of the charges may be carried out separately without overlapping with each other. The method of driving the solid-state imaging device when the exposure and the injection of the charges are separately carried out will be described now.

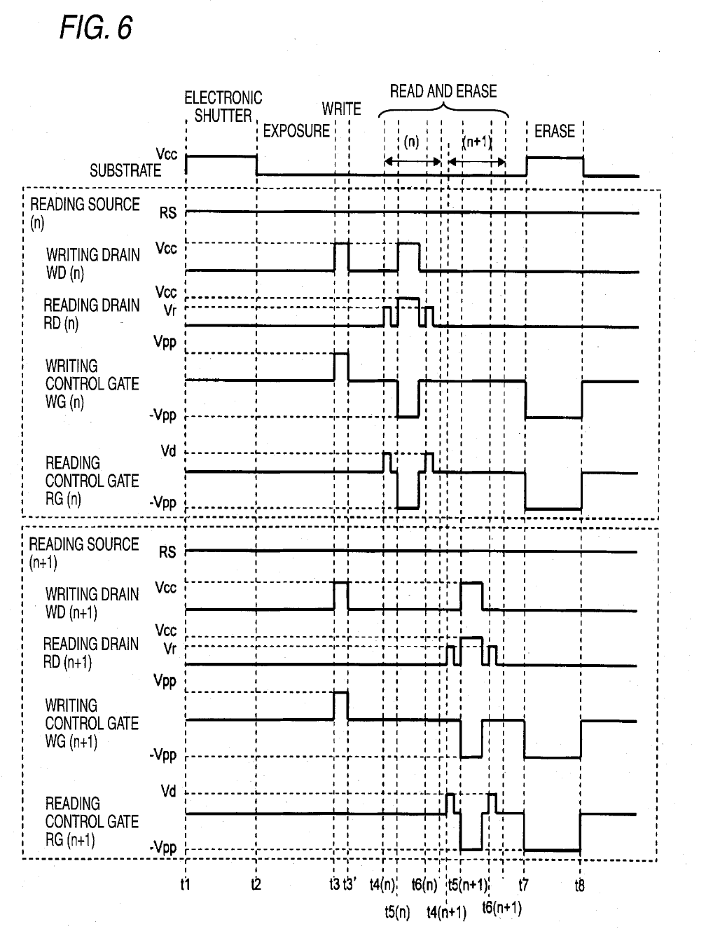

FIG. 6 is a timing diagram illustrating a modified example of the driving method in the still image capturing mode shown in FIG. 4. In FIG. 6, variations in potential of the portions of the pixel units 100 in the n-th line and variations in potential of the portions of the pixel units 100 in the (n+1)-th line are shown with the time. In FIG. 6, “(n)” or “(n+1)” added to the names of the elements of the solid-state imaging device indicates that the elements belong to the pixel units 100 in the n-th line or the (n+1)-th line.

While the driving method shown in FIG. 4 includes simultaneously carrying out the exposure and the injection of the charges into the floating gates FG, the driving method shown in FIG. 6 includes separately carrying out the exposure and the injection of the charges into the floating gates FG.

The drive operations of times t1 to t2 are the same as shown in FIG. 4.

At time t2 which is the start time of the exposure period based on the image capture conditions, the control unit 40 sets the potential of the semiconductor substrate to the low level. At this time, the potentials of the writing control gates WG and the writing drains WD of all the pixel units 100 are set to the low level, whereby the charges generated in the photoelectric conversion portions 3 are not injected into the floating gates FG by the writing transistors WT. By this voltage setting, the charges generated in the photoelectric conversion portions 3 of all the pixel units 100 during the exposure period are accumulated in the photoelectric conversion portions 3. Since the potential of the writing drains WD is set to the low level, the dark current generated in the writing drains WD decreases. Since the potential of the writing control gates WG is set to the low level, the dark current is not injected into the floating gates FG and any noise is not mixed into the floating gates FG.

At time t3 which is the end time of the exposure period (the start time of the writing period), the control unit 40 sets the potential of the writing control gates WG of all the pixel units 100 to Vpp and sets the potential of the writing drains WD to Vcc. By this voltage setting, the charges accumulated in the photoelectric conversion portions 3 during the exposure period are injected into the floating gates FG through the oxide film 11 (CHE injection). The control unit 40 sets the voltage of the reading drains RD of all the pixel units 100 to the low level so as to suppress the charges from leaking from the reading drains RD during the writing period. Accordingly, it is possible to prevent the decrease in sensitivity.

In the writing period from time t3 to time t3′, there is a risk that noise resulting from the dark current from the writing drains WD may be injected into the floating gates FG. However, since the writing period is much shorter than the exposure period, the noise resulting from the dark current generated in this period can be negligibly low. When the charges are injected into the floating gates FG using the tunnel electron injection method by setting the potential of the writing drains WD in the writing period to the low level, it is possible to further reduce the noise.

In this way, the charges are simultaneously accumulated in all the pixel units 100 during the exposure period from time t2 to time t3. During the writing period from time t3 to time t3′, the charges are simultaneously injected into the floating gates FG of all the pixel units 100. The thickness or the like of the oxide film 11 is adjusted to inject rapidly and satisfactorily the charges accumulated in the photoelectric conversion portions 3 into the floating gates FG.

At the end time of the writing period (time t3′), the control unit 40 sets the potentials of the writing control gates WG and the writing drains WD of all the pixel units 100 to the low level. Accordingly, the charges generated in the photoelectric conversion portions 3 of all the pixel units 100 after time t3′ are not injected into the floating gates FG and the writing of charges is ended. The drive operations (at times t4(n) to t6(n) and times t4(n+1) to t6(n+1)) after the end of the writing period are the same as shown in FIG. 4.

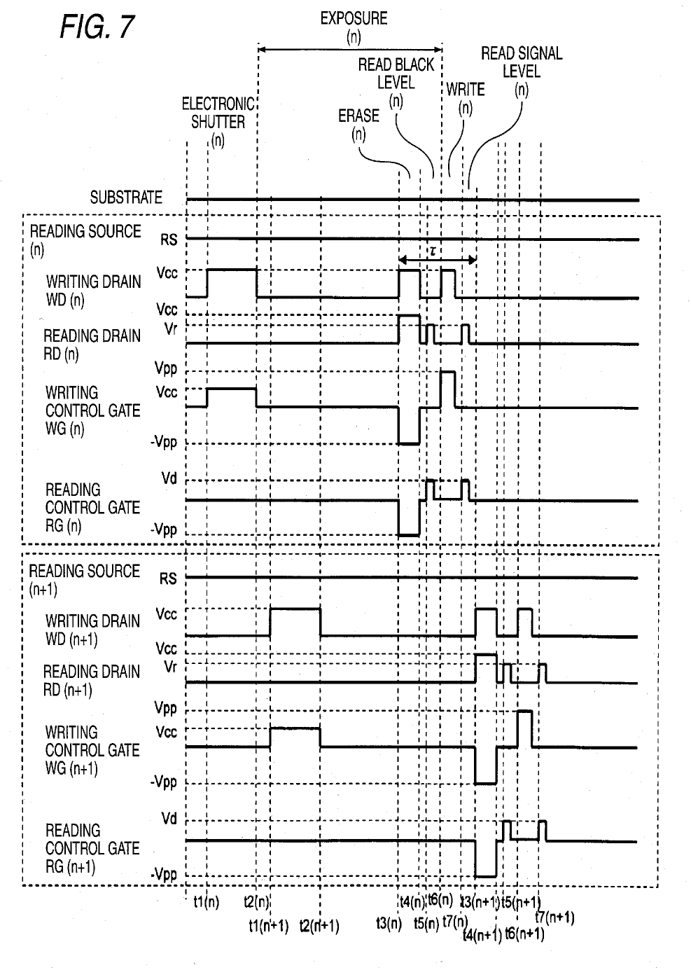

FIG. 7 is a timing diagram illustrating a modified example of the driving method in the moving image capturing mode shown in FIG. 5. In FIG. 7, variations in potential of the portions of the pixel units 100 in the n-th line and variations in potential of the portions of the pixel units 100 in the (n+1)-th line are shown with the time. In FIG. 7, “(n)” or “(n+1)” added to the names of the elements of the solid-state imaging device indicates that the elements belong to the pixel units 100 in the n-th line or the (n+1)-th line.

While the driving method shown in FIG. 5 includes simultaneously carrying out the exposure and the injection of the charges into the floating gates FG on every line, the driving method shown in FIG. 7 includes separately carrying out the exposure and the injection of the charges into the floating gates FG While the driving method shown in FIG. 5 includes reading the second signal by reading the first signal and then performing the charge erasing drive operation after the injection of the charges, the driving method according to the modified example includes first performing the charge erasing drive operation to read the second signals, then injecting the charges, thereafter reading the first signals.

The drive operations before time t2(n) are the same as shown in FIG. 5. At time t2(n), the control unit 40 sets the potentials of the writing control gates WG and the writing drains WD of the pixel units 100 in the n-th line low, whereby the charges generated in the photoelectric conversion portions 3 of the pixel units 100 in the n-th line are not injected into the floating gates FG by the writing transistors WT. By this voltage setting, the charges generated in the photoelectric conversion portions 3 during the exposure period are accumulated in the photoelectric conversion portions 3. Since the potential of the writing drains WD is set to the low level, the dark current generated in the writing drains WD decreases. Since the potential of the writing control gates WG is set to the low level, the dark current is not injected into the floating gates FG and any noise is hardly mixed into the floating gates FG.

At time t3(n) just before the end of the exposure period of the pixel units 100 in the n-th line, the control unit 40 performs the charge erasing drive operation (drain erasing drive operation) by setting the potentials of the writing control gates WG and the reading control gates RG of the pixel units 100 in the n-th line to −Vpp and setting the potentials of the writing drains WD and the reading drains RD of the pixel units 100 in the n-th line to Vcc. Accordingly, the charges accumulated in the floating gates FG at this time are discharged to the writing drains WD and the reading drains RD.

The control unit 40 returns the potentials the writing control gates WG, the reading control gates RG, the writing drains WD, and the reading drains RD of the pixel units 100 in the n-th line to the low level and ends the drain erasing drive operation (time t4(n)).

Thereafter, the control unit 40 pre-charges the reading drains RD of the pixel units 100 in the n-th line and then starts applying a ramp waveform voltage to the reading control gates RG of the pixel units 100 in the n-th line (time t5(n)). The count value (second signal) corresponding to the value of the ramp waveform voltage at the time the potential of the reading drains RD in the n-th line is dropped is held in the reading circuits 20 and the second signal is sampled and held by the CDS circuit 80.

At the end time of the exposure period (time t6(n)) when the reading of the second signal is ended, the control unit 40 sets the potentials of the writing drains WD of the pixel units 100 in the n-th line to Vcc and sets the potentials of the writing control gates WG to Vpp. By this voltage setting, the charges accumulated in the photoelectric conversion portions 3 during the exposure period are injected into the floating gates FG through the oxide film 11 (CHE injection). To suppress the charges from leaking from the reading drains RD during the writing period, the control unit 40 sets the voltages of the reading drains RD of the pixel units 100 in the n-th line low. Accordingly, it is possible to prevent the decrease in sensitivity. During the writing period, the potential of the writing drains WD may be set low and the charges may be injected into the floating gates FG using the tunnel electron injection method.

At the end time of the writing period of the pixel units 100 in the n-th line, the control unit 40 sets the potentials of the writing control gates WG and the writing drains WD of the pixel units 100 in the n-th line low. Accordingly, the charges generated in the photoelectric conversion portions 3 of the pixel units 100 in the n-th line after the end of the writing period are not injected into the floating gates FG and the writing of charges is ended.

Then, the control unit 40 pre-charges the reading drains RD of the pixel units 100 in the n-th line and then starts applying a ramp waveform voltage to the reading control gates RG of the pixel units 100 in the n-th line (time t7(n)). The count value (first signal) corresponding to the value of the ramp waveform voltage at the time the potential of the reading drains RD in the n-th line is dropped is held in the reading circuits 20 and the first signal is sampled and held by the CDS circuit 80.

The CDS circuits 80 hold the first signals read from the pixel units 100 in the n-th line and then generates the image capturing signal for generating the image data by subtracting the second signals held in advance and read from the pixel units 100 in the n-th line from the first signals. Then, when one horizontal selection transistor 30 is selected by the horizontal shift register 50, the image capturing signal generated by the CDS 80 connected to the selected horizontal selection transistor 30 is output to the signal line 70 and is output from the output amplifier 60.

In this way, the control unit 40 performs the charge erasing operation and the second signal reading operation during the exposure period and continuously performs the charge injecting operation and the first signal reading operation after the end of the exposure period. When the time taken to perform the charge erasing operation, the second signal reading operation, the charge injecting operation, and the first signal reading operation is τ, the control unit 40 performs the drive operations of times t1(n) to t7(n) at different times by the time τ by the lines. The times obtained by adding τ to times t1(n) to t7(n) are t1(n+1) to t7(n+1).

In the driving methods shown in FIGS. 6 and 7, since the charges are not injected into the floating gates FG during the exposure period, it is possible to lower the possibility that the noise generated during the exposure period is mixed into the floating gates FG The injection of the charges generated during the exposure period into the floating gates FG can be carried out for a time much shorter than the exposure period. Accordingly, the mixture of the noise into the floating gates FG during the period (writing period) when the charges are injected can be reduced to a negligible extent. As a result, according to the driving method shown in FIG. 6, it is possible to reduce the noises included in the first signals.

According to the driving method shown in FIG. 7, since the charge erasing drive operation, the second signal reading operation, the charge injecting operation, and the first signal reading operation are carried out in this order, it is possible to read the first signals including the second signals as the noises after reading the second signals. Therefore, the signals obtained by subtracting the second signals from the first signals are matched exactly with the signals corresponding to the charges generated in the photoelectric conversion portions during the exposure period and thus it is possible to exactly remove the noises mixed into the floating gates FG.

In the above description, the method of discharging the charges generated in the photoelectric conversion portions 3 to the writing drains WD through the channel regions of the writing transistors WT is employed as the drain discharging drive method, but a method of discharging the charges generated in the photoelectric conversion portions 3 to the reading drains RD through the floating gates FG may be employed.

In this case, in order to erase the charges from the photoelectric conversion portions 3, the control unit 40 can inject the charges in the photoelectric conversion portions 3 into the floating gates FG by setting the potential of the writing drains WD to Vcc or the low level and setting the potential of the writing control gates WG to Vpp, and can instantaneously discharge the charges injected into the floating gates FG to the reading drains RD by setting the potentials of the reading control gates RD to −Vpp and setting the potential of the reading drains RD to Vcc.

In the above description, the charges accumulated in the floating gates FG are discharged to the writing drains WD and the reading drains RD at the time of performing the drain erasing drive operation, but the discharge destination of the charges may be one thereof. That is, at the time of performing the drain erasing drive operation in FIGS. 4, 5, 6, and 7, a drive method of setting the potentials of the writing drains WD or the reading drains RD to the low level may be employed.

In the above description, each pixel unit 100 includes two transistors of the writing transistor WT and the reading transistor RT, but the functions of the writing transistor WT and the reading transistor RT may be performed by one transistor.

For example, in FIG. 2, the reading transistor RT may be omitted and the writing drain WD may be connected to the reading circuit 20 via the column signal line 12. In this configuration, it is possible to read the voltage signals from the pixel units 100 by setting the potential of the writing drain WD to Vr and applying the ramp waveform voltage to the writing control gate WG, for example, in the driving methods shown in FIGS. 4 to 7.

When the accumulating of the charges, the reading of the signals, and the erasing of the charges are carried out using one transistor, the charge discharging passage at the time of erasing the charges includes only the writing drains WD. On the contrary, in the configuration shown in FIG. 2, the charge discharging passage at the time erasing the charges includes both of the writing drains WD and the reading drains RD. Accordingly, it is possible to smoothly discharge the charges and to reduce the charge discharging time or satisfactorily prevent the charges from remaining in the floating gate FG, thereby improving the charge discharging efficiency at the time of performing the drain erasing drive operation. As a result, it is possible to capture a high-quality image with a suppressed afterimage.

As described above, when the reading portion is embodied by one transistor, a structure other than the MOS structure may be employed by the transistor. For example, an MNOS transistor structure in which the floating gate FG shown in FIG. 2 is formed of a nitride film and the writing control gate WG is formed directly on the nitride film and an MONOS structure in which the floating gate FG shown in FIG. 2 is formed of a nitride film may be employed. A trap level of the film including the nitride film and the oxide film 11 serves as the charge accumulating portion for accumulating the charges in the MNOS and the nitride film serves as the charge accumulating portion for accumulating the charges in the MONOS.

In the above description, the photoelectric conversion portion 3 is formed in the semiconductor substrate, but the invention is not limited to this configuration.

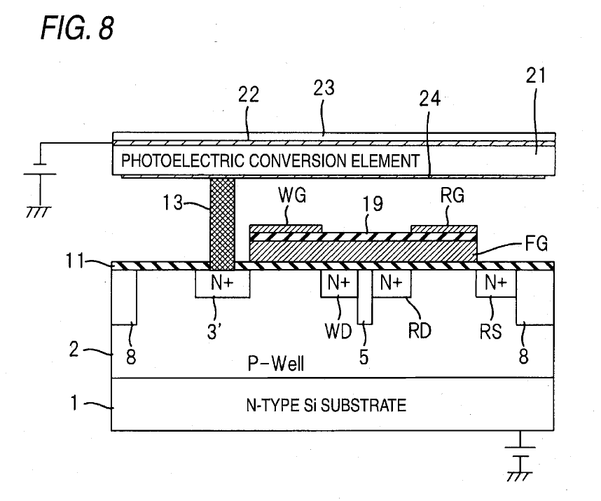

FIG. 8 is a sectional view schematically illustrating another configuration of the pixel unit of the solid-state imaging device shown in FIG. 1A. In the pixel unit shown in FIG. 8, an N-type impurity layer 3′ is disposed instead of the P-type impurity layer 9 and the photoelectric conversion portion 3 of the pixel unit shown in FIG. 2. The N-type impurity layer 3′ serves as a source region of the writing transistor WT.

Pixel electrodes 24 separating every pixel unit are formed on the semiconductor substrate. A photoelectric conversion film 21 is formed on the pixel electrodes 24 and a counter electrode 22 is formed on the photoelectric conversion film 21. A passivation film 23 transmitting incident light is formed on the counter electrode 22.

The counter electrode 22 is formed of a conductive material (for example, a metal compound such as ITO or a very thin metal film) transmitting the incident light and is common to all the pixel units. The photoelectric conversion film 21 is a film formed of an organic or inorganic photoelectric conversion material generating charges depending on the incident light and is common to all the pixel units. The photoelectric conversion film 21 can be formed of, for example, an amorphous silicon or a CIGS (Copper-Indium-Gallium-Selenium)-based material.

The counter electrode 22 and the photoelectric conversion film 21 may separate every pixel unit 100. The counter electrode 22 may have a structure in which rectangular electrodes are wired in common.

The N-type impurity layer 3′ is connected to the pixel electrode 24 via a plug 13 formed of a conductive material such as aluminum and is thus electrically connected to the photoelectric conversion film 21.

In the solid-state imaging device having the above-mentioned structure, when the exposure period is started, the charges generated in the photoelectric conversion film 21 during the exposure period move to the N-type impurity layer 3′ via the pixel electrode 24 and the plug 13. Then, the charges moving to the N-type impurity layer 3′ are injected into the floating gate FG through the oxide film 11.

Accordingly, even the solid-state imaging device having the structure in which the photoelectric conversion portion is disposed on the semiconductor substrate can exhibit the same advantages as described above. In the configuration shown in FIG. 8, since the photoelectric conversion portion is disposed above the reading portion, the opening can be taken wide, thereby improving the sensitivity. Therefore, it is possible to provide a high-quality image particularly at a low intensity of illumination.

In the above description, it is assumed that the charges to be treated (charges taken out as the image capturing signal) are electrons, but the same idea is applied to the case when the charges to be treated are holes. When the charges to be treated are holes, the N regions and the P regions in the drawing may be exchanged and the polarities of the voltages applied to the portions may be inverted.

What is claimed is:

1. An imaging apparatus comprising:
pixel groups;
a driving unit that independently performs a charge erasing drive operation, a first signal reading drive operation and a second signal reading drive operation for the respective pixel groups; and
a signal generating unit,
wherein each pixel group includes plural pixel units,
each pixel unit includes
a photoelectric conversion portion, and
a transistor having a charge accumulating portion which is disposed above a semiconductor substrate and which accumulates electric charges generated in the photoelectric conversion portion,
the charge erasing drive operation discharges and erases the electric charges in the charge accumulating portions of the pixel units of each pixel group to drain regions of the transistors of the pixel units of each pixel group,
the first signal reading device operation is performed after the electric charges which are generated during an exposure period are accumulated in the charge accumulating portion,
the first signal reading device operation reads first signals corresponding to the electric charges accumulated in the charge accumulating portions of each pixel group,
the second signal drive operation reads second signals corresponding to the electric charges in the charge accumulating portions of each pixel group after the electric charges in the charge accumulating portions of each pixel group are discharged to the drain regions of the transistors of each pixel group by the charge erasing drive operation, and
the signal generating unit generates a signal for generation of image data, by acquiring the first signal and the second signal which are read from the same pixel unit and subtracting the second signal from the first signal.

2. The imaging apparatus according to claim 1,
wherein the driving unit performs a substrate discharging drive operation of simultaneously discharging the electric charges generated in the photoelectric conversion portions of all the pixel units to the semiconductor substrate,
in a still image capturing mode, the driving unit performs the substrate discharging drive operation and simultaneously starts the exposure period in all the pixel units, and then performs a series of the first signal reading drive operation, the charge erasing drive operation and the second signal reading drive operation in this order for each pixel group after an end of exposure period, and
timings at which the series of the first signal reading drive operation, the charge erasing drive operation and the second signal reading drive operation are performed for the respective pixel groups are different from each other.

3. The imaging apparatus according to claim 1,
wherein the transistor of each pixel unit is a writing transistor for injecting and accumulating the electric charges in the charge accumulating portion of each pixel unit, and
the driving unit drives the writing transistors to inject the electric charges, which are generated in the photoelectric conversion portions during the exposure period, into the charge accumulating portions during the exposure period.

4. The imaging apparatus according to claim 1,
wherein the transistor of each pixel unit is a writing transistor for injecting and accumulating the electric charges in the charge accumulating portion of each pixel unit, and
the driving unit drives the writing transistors to stop, during the exposure period, injecting the electric charges, which are generated in the photoelectric conversion portions, into the charge accumulating portions, and drives the writing transistors to inject the electric charges, which are generated in the photoelectric conversion portions during the exposure period, into the charge accumulating portions after an end of the exposure period.

5. The imaging apparatus according to claim 1,
wherein the driving unit performs a discharging drive operation of discharging the electric charges generated in the photoelectric conversion portion of each pixel unit to the drain region of the transistor in each pixel unit,
in a moving image capturing mode, the driving unit performs a series of (I) the discharging drive operation, (II) starting of the exposure period, (III) the first signal reading drive operation, (IV) the charge erasing drive operation, and (V) the second signal reading drive operation in this order for each pixel groups, and
timings at which the series of (I) the discharging drive operation, (II) the starting of the exposure period, (III) the first signal reading drive operation, (IV) the charge erasing drive operation, and (V) the second signal reading drive operation are performed for the respective pixel groups are different from each other.

6. The imaging apparatus according to claim 5,
wherein the transistor of each pixel unit is a writing transistor for injecting and accumulating the electric charges in the charge accumulating portion of each pixel unit, and
the driving unit drives the writing transistors to inject the electric charges, which are generated in the photoelectric conversion portions during the exposure period, into the charge accumulating portions during the exposure period.

7. The imaging apparatus according to claim 5,
wherein the transistor of each pixel unit is a writing transistor for injecting and accumulating the electric charges in the charge accumulating portion of each pixel unit, and
the driving unit drives the writing transistors to stop, during the exposure period, injecting the electric charges, which are generated in the photoelectric conversion portions, into the charge accumulating portions, and drives the writing transistors to inject the electric charges, which are generated in the photoelectric conversion portions during the exposure period, into the charge accumulating portions after the end of the exposure period.

8. The imaging apparatus according to claim 1,
wherein the driving unit performs a discharging drive operation of discharging the electric charges generated in the photoelectric conversion portion of each pixel unit to the drain region of the transistor in each pixel unit,
the transistor of each pixel unit is a writing transistor for injecting and accumulating the electric charges in the charge accumulating portion of each pixel unit,
in a moving image capturing mode, the driving unit performs a series of (I) the discharging drive operation, (II) starting of the exposure period, (III) the charge erasing drive operation, (IV) the second signal reading drive operation, (V) an operation of driving the writing transistor after an end of the exposure period to inject the electric charges, which are generated in the photoelectric conversion portion during the exposure period, into the charge accumulating portion and (VI) the first signal reading drive operation in this order for each pixel group, and
timings at which the series of (I) the discharging drive operation, (II) the starting of the exposure period, (III) the charge erasing drive operation, (IV) the second signal reading drive operation, (V) the operation of driving the writing transistor after the end of the exposure period and (VI) the first signal reading drive operation are performed for the respective pixel groups are different from each other.

9. The imaging apparatus according to claim 6,
wherein the discharging drive operation is a drive operation of discharging the electric charges generated in the photoelectric conversion portions of each pixel group to the drain regions of the writing transistors of each pixel group through channel regions of the writing transistors of each pixel group by applying to the gate electrodes of the writing transistors of each pixel group a second voltage lower than a first voltage to be applied to the gate electrodes of the writing transistors of each pixel group to inject the electric charges into the charge accumulating portions of each pixel group by the use of the writing transistors of each pixel group.

10. The imaging apparatus according to claim 6,
wherein each pixel unit further includes a reading transistor for reading a signal corresponding to the electric charges accumulated in the charge accumulating portion, and
in each pixel unit,
the charge accumulating portion includes a floating gate, and
the floating gate of the writing transistor and a floating gate of the reading transistor are electrically connected to each other, and
the discharging drive operation is a drive operation of injecting the electric charges generated in the photoelectric conversion portions of each pixel group into the floating gates of the writing transistors of each pixel group and discharging the electric charges injected into the floating gates of each pixel group to the drain region of the reading transistors of each pixel group.

11. The imaging apparatus according to claim 1,
wherein each photoelectric conversion portion includes a photoelectric conversion element disposed above the semiconductor substrate.

12. The imaging apparatus according to claim 11,
wherein each photoelectric conversion element is formed of one of an amorphous silicon, a CIGS (Copper-Indium-gallium-selenium)-based material, and an organic material.

13. A method of driving a solid-state imaging device including pixel groups,
wherein each pixel group includes plural pixel units,
each pixel unit includes
a photoelectric conversion portion, and
a transistor having a charge accumulating portion which is disposed above a semiconductor substrate and which accumulates electric charges generated in the photoelectric conversion portion,
the method comprising:
independently performing a charge erasing drive operation, a first signal reading drive operation and a second signal reading drive operation for the respective pixel groups; and
generating a signal for generation of image data,
wherein the charge erasing drive operation discharges and erases the electric charges in the charge accumulating portions of the pixel units of each pixel group to drain regions of the transistors of the pixel units of each pixel group,
the first signal reading device operation is performed after the electric charges which are generated during an exposure period are accumulated in the charge accumulating portion,
the first signal reading device operation reads first signals corresponding to the electric charges accumulated in the charge accumulating portions of each pixel group,
the second signal drive operation reads second signals corresponding to the electric charges in the charge accumulating portions of each pixel group after the electric charges in the charge accumulating portions of each pixel group are discharged to the drain regions of the transistors of each pixel group by the charge erasing drive operation, and
the generating of the signal includes acquiring the first signal and the second signal which are read from the same pixel unit and subtracting the second signal from the first signal.

14. The method of driving a solid-state imaging device according to claim 13,
wherein in a still image capturing mode,
a substrate discharging drive operation of simultaneously discharging the electric charges generated in the photoelectric conversion portions of all the pixel units to the semiconductor substrate is performed,
the exposure period in all the pixel units are started simultaneously, and
a series of the first signal reading drive operation, the charge erasing drive operation and the second signal reading drive operation are performed in this order for each pixel group after an end of exposure period, and
timings at which the series of the first signal reading drive operation, the charge erasing drive operation and the second signal reading drive operation are performed for the respective pixel groups are different from each other.

15. The method of driving a solid-state imaging device according to claim 13,
wherein the transistor of each pixel unit is a writing transistor for injecting and accumulating the electric charges in the charge accumulating portion of each pixel unit, and
the writing transistors are driven during the exposure period to inject the electric charges, which are generated in the photoelectric conversion portions during the exposure period, into the charge accumulating portions.

16. The method of driving a solid-state imaging device according to claim 13,
wherein the transistor of each pixel unit is a writing transistor for injecting and accumulating the electric charges in the charge accumulating portion of each pixel unit, and
the writing transistors are driven to stop, during the exposure period, injecting the electric charges, which are generated in the photoelectric conversion portions, into the charge accumulating portions, and
after an end of the exposure period, the writing transistors are driven to inject the electric charges, which are generated in the photoelectric conversion portions during the exposure period, into the charge accumulating portions.

17. The method of driving a solid-state imaging device according to claim 13,
wherein in a moving image capturing mode,
a discharging drive operation of discharging the electric charges generated in the photoelectric conversion portion of each pixel unit to the drain region of the transistor in each pixel unit, and
a series of (I) the discharging drive operation, (II) starting of the exposure period, (III) the first signal reading drive operation, (IV) the charge erasing drive operation, and (V) the second signal reading drive operation are performed in this order for each pixel groups, and
timings at which the series of (I) the discharging drive operation, (II) the starting of the exposure period, (III) the first signal reading drive operation, (IV) the charge erasing drive operation, and (V) the second signal reading drive operation are performed for the respective pixel groups are different from each other.

18. The method of driving a solid-state imaging device according to claim 17,
wherein the transistor of each pixel unit is a writing transistor for injecting and accumulating the electric charges in the charge accumulating portion of each pixel unit, and
the writing transistors are driven during the exposure period to inject the electric charges, which are generated in the photoelectric conversion portions during the exposure period, into the charge accumulating portions.

19. The method of driving a solid-state imaging device according to claim 17,
wherein the transistor of each pixel unit is a writing transistor for injecting and accumulating the electric charges in the charge accumulating portion of each pixel unit, and
the writing transistors are driven to stop, during the exposure period, injecting the electric charges, which are generated in the photoelectric conversion portions, into the charge accumulating portions, and
after an end of the exposure period, the writing transistors are driven to inject the electric charges, which are generated in the photoelectric conversion portions during the exposure period, into the charge accumulating portions.

20. The method of driving a solid-state imaging device according to claim 13,
wherein the transistor of each pixel unit is a writing transistor for injecting and accumulating the electric charges in the charge accumulating portion of each pixel unit,
in a moving image capturing mode,
a discharging drive operation of discharging the electric charges generated in the photoelectric conversion portion of each pixel unit to the drain region of the transistor in the pixel unit is performed, and
a series of (I) the discharging drive operation, (II) starting of the exposure period, (III) the charge erasing drive operation, (IV) the second signal reading drive operation, (V) an operation of driving the writing transistor after an end of the exposure period to inject the electric charges, which are generated in the photoelectric conversion portion during the exposure period, into the charge accumulating portion and (VI) the first signal reading drive operation are performed in this order for each pixel group, and
timings at which the series of (I) the discharging drive operation, (II) the starting of the exposure period, (III) the charge erasing drive operation, (IV) the second signal reading drive operation, (V) the operation of driving the writing transistor after the end of the exposure period into the charge accumulating portion and (VI) the first signal reading drive operation for the respective pixel groups are different from each other.

21. The method of driving a solid-state imaging device according to claim 18,
wherein the discharging drive operation is a drive operation of discharging the electric charges generated in the photoelectric conversion portions of each pixel group to the drain regions of the writing transistors of each pixel group through channel regions of the writing transistors of each pixel group by applying to the gate electrodes of the writing transistors of each pixel group a second voltage lower than a first voltage to be applied to the gate electrodes of the writing transistors of each pixel group to inject the electric charges into the charge accumulating portions of each pixel group by the use of the writing transistors of each pixel group.

22. The method of driving a solid-state imaging device according to claim 18,
wherein each pixel unit further includes a reading transistor for reading a signal corresponding to the electric charges accumulated in the charge accumulating portion, and
in each pixel unit,
the charge accumulating portion includes a floating gate, and
the floating gate of the writing transistor and a floating gate of the reading transistor are electrically connected to each other, and
the discharging drive operation is a drive operation of injecting the electric charges generated in the photoelectric conversion portions of each pixel group into the floating gates of the writing transistors of each pixel group and discharging the electric charges injected into the floating gates of each pixel group to the drain region of the reading transistors of each pixel group.

23. The method of driving a solid-state imaging device according to claim 13,
wherein each photoelectric conversion portion includes a photoelectric conversion element disposed above the semiconductor substrate.

24. The method of driving a solid-state imaging device according to claim 23,
wherein each photoelectric conversion element is formed of one of an amorphous silicon, a CIGS (Copper-Indium-gallium-selenium)-based material, and an organic material.
